(19) United States
(12) Patent Application Publication
(10) Pub. No.: US 2009/0013343 A1
(43) Pub. Date: Jan. 8, 2009

(54) Disk Apparatus

(75) Inventors: Goro Naoki, Osaka (JP); Masahiro Inata, Hyogo (JP); Tetsuro Tanaka, Osaka (JP); Yoshito Saji, Hyogo (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi, Osaka (JP)

(21) Appl. No.: 11/573,027

(22) PCT Filed: Sep. 7, 2005
(86) PCT No.: PCT/JP05/16410

§ 371 Date: Jan. 31, 2007

(30) Foreign Application Priority Data
Sep. 7, 2004 (JP) 2004-259219

(51) Int. Cl. G11B 17/028

(52) U.S. Cl. 720/704

(57) ABSTRACT

A motor (2) for rotating a disk; a head (3) for recording/reproducing information of the disk; a tray (1) on which a first cartridge and a second cartridge that accommodate the disk respectively and have different outside shapes can be mounted selectively; a transferer (7, 1k) for transferring the tray (1); a detector (4) for detecting an outside shape difference between the respective cartridges; a disk cartridge guide (1d) for positioning the respective cartridges such that, when mounting the respective cartridges on the tray (1), centers of the respective disks accommodated in the respective cartridges do not coincide with each other; and a transferring distance changer (5, 10a, 1g, 1h, 1i) that can change a transferring distance of the tray (1) of the transferer (7, 1k) based on a result of the detector (4), and can transfer the tray (1) to a position where the centers of the respective disks accommodated in the respective cartridges coincide with a substantial center of the motor (2) are provided.

### TECHNICAL FIELD

The present invention relates to a disk apparatus using a disk that is an information recording medium for video images, music, computer data and the like, and particularly relates to a tray on which a cartridge is mounted and positioning thereof.

### BACKGROUND ART

Recently, large-capacity optical disks such as DVD-RAMs have been prevalent as storage means for large-capacity information such as recording computers. Moreover, high-resolution broadcasting has started, and demands for even higher image quality and longer time recording have increased. Since the further increase of a capacity for attaining them requires shortening a wavelength of a red laser, it is necessary to use a system other than a current DVD-RAM system.

In view of this, development of a blue ray disk (hereinafter, called a “BD”), which can increase a capacity by making a signal fine by using a blue laser that can increase the capacity further, has proceeded. Moreover, since the BD makes a signal still finer than a DVD -RAM, it is necessary to use a cartridge that is designed for dealing with dust more reliably, which is different from that of the DVD-RAM.

As a result, a cartridge of the DVD-RAM and a cartridge of the BD have structures with different outside shapes, or different positional relationships between: a center of a disk accommodated in the cartridge; and a hole for positioning the cartridge. In order to be able to operate these cartridges with one drive, for example, a method for moving a disk motor block or a pair of positioning pins in accordance with a cartridge type detector is suggested in Patent document 1.

However, in the conventional technique described above, a large number of members are necessary, and it is not easy to secure the positioning precision and operational reliability. Moreover, there is a problem in that, when rotating a disk with a large mass eccentricity at a high speed, the members are likely to be vibrated so as to generate noises.

Further, if a pin for positioning the cartridge protrudes from the tray, there is a problem in that, when mounting the disk directly, the disk is in contact with the pin so as to be damaged or the like.

Patent document 1: JP 2003-162860 A

### DISCLOSURE OF INVENTION

The object of the present invention is to solve the conventional problems as described above, and to provide a disk apparatus that can operate a plurality of cartridges having different positional relationships between: a center of a disk accommodated in a cartridge; and a hole for positioning the cartridge with one device, can reduce the number of members so as to facilitate ensuring the reliability, and can improve the reliability in the case of mounting the disk directly.

In order to attain the object described above, a first disk apparatus of the present invention includes: a motor for rotating a disk having an information recording layer; a head for recording information onto the information recording layer and/or reproducing the information of the information recording layer; a tray on which a first cartridge and a second cartridge that accommodate the disk respectively and have different outside shapes can be mounted selectively; a transferer for transferring between: a mounting position where the first cartridge or the second cartridge is mounted on the tray; and a recording/reproducing position where the head records and/or reproduces the information with respect to the information recording layer; a detector for detecting an outside shape difference between the first cartridge and the second cartridge; a disk cartridge guide for positioning the respective cartridges such that, when mounting the respective cartridges on the tray, centers of the respective disks accommodated in the respective cartridges do not coincide with each other; and a transferring distance changer that can change a transferring distance of the tray of the transferer based on a result of the detector, and can transfer the tray to a position where the centers of the respective disks accommodated in the respective cartridges coincide with a substantial center of the motor.

A second disk apparatus of the present invention includes: a motor for rotating a disk having an information recording layer;

a head for recording information onto the information recording layer and/or reproducing the information of the information recording layer; a tray on which a simplex of the disk, a first cartridge and a second cartridge that accommodate the disk respectively and have different outside shapes can be mounted selectively; a transferer for transferring between: a mounting position where the simplex of the disk, the first cartridge or the second cartridge is mounted on the tray; and a recording/reproducing position where the head records and/or reproduces the information with respect to the information recording layer; a detector for detecting an outside shape difference between the simplex of the disk, the first cartridge and the second cartridge; a disk cartridge guide for positioning the respective cartridges such that, when mounting the respective cartridges on the tray, centers of the respective disks accommodated in the respective cartridges do not coincide with each other, wherein, when mounting the simplex of the disk on the tray, the center of the simplex of the disk substantially coincides with the center of the disk accommodated in the first cartridge or the second cartridge when being mounted on the tray; and further including a transferring distance changer that can change a transferring distance of the tray of the transferer based on a result of the detector, and can transfer the tray to a position where a center of the simplex of the disk and the centers of the respective disks accommodated in the respective cartridges coincide with a substantial center of the motor.

Incidentally, the outside shape difference of the present invention represents a shape difference and/or a size difference of a face that is parallel with the accommodated disk.

A third disk apparatus of the present invention includes: a motor for rotating the disk having the information recording layer; a head for recording the information onto the information recording layer and/or reproducing the information of the information recording layer; a tray that accommodates the disk and can mount a cartridge provided with a pair of positioning holes; and a transferer for transferring between: a mounting position where the cartridge is mounted on the tray; and a recording/reproducing position where the head records and/or reproduces the information with respect to the information recording layer, wherein the tray includes: a pair of positioning pins that are inserted into the pair of the positioning holes, and a pin cover that is disposed on a periphery of the pair of the positioning pins, and is buried under a mounting face of the tray when the cartridge is mounted.

### BRIEF DESCRIPTION OF DRAWINGS

FIG. 1 is a perspective view showing a relevant part of a disk apparatus according to an embodiment of the present invention.

FIG. 2 is a plan view showing a DVD-RAM cartridge.

FIG. 3 is a plan view showing a BD cartridge.

FIG. 4 is a plan view before mounting a cartridge according to an embodiment of the present invention.

FIG. 5 is a plan view when mounting a RAM cartridge according to an embodiment of the present invention.

FIG. 6 is a plan view explaining an operation when mounting a RAM cartridge according to an embodiment of the present invention.

FIG. 7 is a plan view explaining an operation when mounting a RAM cartridge according to an embodiment of the present invention.

FIG. 8 is a plan view explaining an operation when mounting a RAM cartridge according to an embodiment of the present invention.

FIG. 9 is a plan view explaining an operation when mounting a RAM cartridge according to an embodiment of the present invention.

FIG. 10 is a plan view when mounting a BD cartridge according to an embodiment of the present invention.

FIG. 11 is a plan view explaining an operation when mounting a BD cartridge according to an embodiment of the present invention.

FIG. 12 is a plan view explaining an operation when mounting a BD cartridge according to an embodiment of the present invention.

FIG. 13 is a plan view explaining an operation when mounting a BD cartridge according to an embodiment of the present

FIG. 14 is a plan view explaining an operation when mounting a BD cartridge according to an embodiment of the present invention.

FIG. 15 is a plan view showing a tray and a track selecting lever according to an embodiment of the present invention.

FIG. 16A is a cross-sectional view explaining operations of a positioning pin and a positioning pin cover according to an embodiment of the present invention, which shows a state where a cartridge is not mounted.

FIG. 16B is a cross-sectional view explaining operations of a positioning pin and a positioning pin cover according to an embodiment of the present invention, which shows a state where a cartridge is mounted.

### DESCRIPTION OF THE INVENTION

According to the first disk apparatus of the present invention, a structure that can attach/detach cartridges having different shapes can be realized with a small number of members, which can facilitate ensuring the reliability.

According to the second disk apparatus of the present invention, a structure that can attach/detach the cartridges having different shapes and the simplex of the disk can be realized with the small number of members, which can facilitate to secure the reliability.

According to the third disk apparatus of the present invention, by the provision of the pin cover, the positioning of the cartridge in its height direction can be achieved, and the designability thereof can be improved. Moreover, if structured to mount the simplex of the disk directly, the disk is not likely to be in touch with the pin directly, thus being suitable for preventing the damage of the disk.

In the first disk apparatus of the present invention, it is preferable that a simplex of the disk can be mounted selectively on the tray, and a center of the simplex of the disk when being mounted on the tray substantially coincides with a center of the disk accommodated in the first cartridge or the second cartridge when being mounted on the tray. According to this structure, the mounting of the simplex of the disk can be realized easily.

Moreover, in the first disk apparatus and second disk apparatus of the present invention, it is preferable that each of the first cartridge and the second cartridge is provided with one or more positioning holes, the first cartridge and the second cartridge have different distances between the positioning holes of the respective cartridges and the centers of the disks accommodated in the respective cartridges, and the disk cartridge guide is a positioning pin that protrudes or is protrudable from the tray, and is inserted into the positioning hole. According to this structure, the plurality of the cartridges having different shapes can be positioned with precision.

Moreover, it is preferable that an inclined portion is formed on a tip of the positioning pin, and the inclined portion is inclined such that a side of the mounting position in a transferring direction of the tray by the transferer is close to a mounting face of the tray. According to this structure, the insertablity of the cartridge can be improved.

Moreover, it is preferable to include a pin cover that is disposed on a periphery of the positioning pin, and is buried under a mounting face of the tray when the respective cartridges are mounted. According to this structure, when mounting the simplex of the disk directly, the disk is not likely to be in touch with the pin, thus being suitable for preventing the damage of the disk and improving the designability.

Moreover, it is preferable that the pin cover is operated by being guided by the positioning pin. According to this structure, the guide for the pin cover is not required additionally, thus simplifying the structure.

Moreover, it is preferable that the simplex of the disk selectively can be mounted on the tray, and the pin cover functions also as a guide when the simplex of the disk is mounted on the tray. According to this structure, the member for guiding the disk can be reduced, thus simplifying the structure.

Moreover, it is preferable that the simplex of the disk selectively can be mounted on the tray, and the pin cover is disposed so as to be extended in a radial manner in a substantial diameter direction of a circle whose center coincides with the center of the simplex of the disk when mounting the simplex of the disk. According to this structure, the design ability can be improved.

Moreover, it is preferable that the pin cover is provided with an inclined face so as to be closer to the mounting face of the tray as being extended in the radial manner. According to this structure, the designability can be improved.

Moreover, it is preferable that an inclining direction of the inclined face of the pin cover substantially coincides with an inclining direction of an inclined portion of the positioning pin. According to this structure, the designability can be improved, and it is suitable for preventing the damage to the disk.

In the third disk apparatus of the present invention, it is preferable that an inclined portion is formed on a tip of the positioning pin, and the inclined portion is inclined such that a side of the mounting position in a transferring direction of the tray by the transferer is close to a mounting face of the tray. According to this structure, the insertablity of the cartridge can be improved.

Moreover, it is preferable that the pin cover operates by being guided by the positioning pin. According to this structure, the guide for the pin cover is not required additionally, thus simplifying the structure.

Moreover, it is preferable that the simplex of the disk selectively can be mounted on the tray, and the pin cover functions also as a guide when the simplex of the disk is mounted on the tray. According to this structure, the member for guiding the disk can be reduced, thus simplifying the structure.

Moreover, it is preferable that the simplex of the disk selectively can be mounted on the tray, and the pin cover is disposed so as to be extended in a radial manner in a substantial diameter direction of a circle whose center coincides with the center of the simplex of the disk when mounting the simplex of the disk. According to this structure, the designability can be improved.

Moreover, it is preferable that the pin cover is provided with an inclined face so as to be closer to the mounting face of the tray as being extended in the radial manner. According to this structure, the designability can be improved.

Moreover, it is preferable that an inclining direction of the inclined face of the pin cover substantially coincides with an inclining direction of an inclined portion of the positioning pin. According to this structure, the designability can be improved.

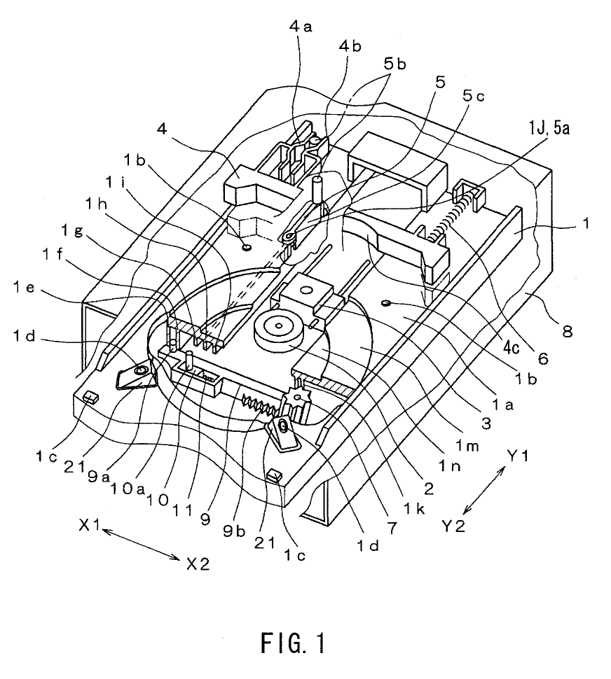

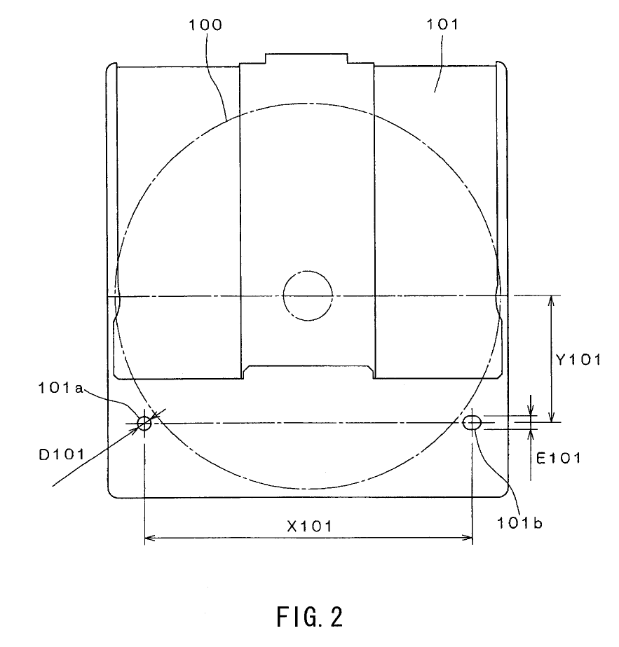

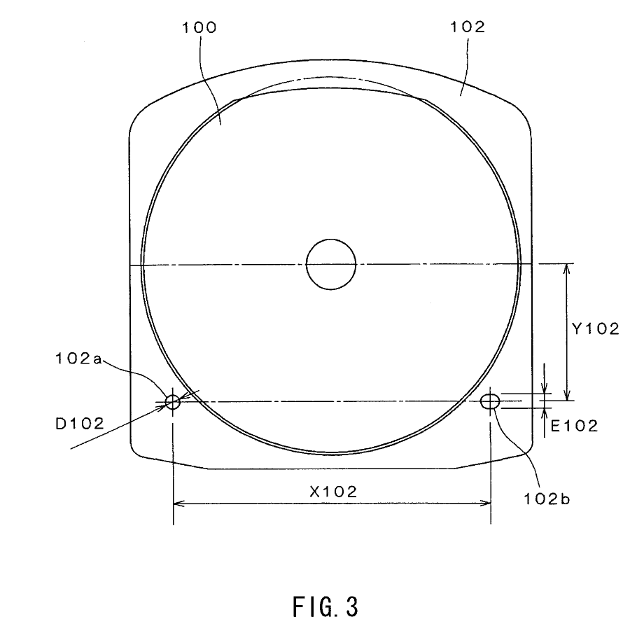

Hereinafter, an embodiment of the present invention will be described with reference to the figures. FIG. 1 is a perspective view showing a relevant part of a disk apparatus according to an embodiment of the present invention. Moreover, FIG. 2 is a plan view showing a DVD-RAM cartridge, and FIG. 3 is a plan view showing a BD cartridge.

Reference numeral 1 denotes a tray, on which a RAM cartridge 101 (FIG. 2) as the first cartridge, a BD cartridge 102 (FIG. 3) as the second cartridge, a disk 100 with an outer diameter of about 12 cm, a disk with an outer diameter of 8 cm that is smaller than the diameter of the disk 100 and the like can be mounted.

A rack 1k structured on the tray 1 is engaged with a gear 7 that is structured on a mechanical pedestal 8 and is driven by a transfer motor (not illustrated), thereby constituting a transferee. By this transferer, the tray 1 can be transferred in directions Y1 and Y2.

More specifically, by the transferee, a simplex of a disk, the RAM cartridge 101 or the BD cartridge 102 are transferred between: a mounting position for mounting on the tray 1; and a recording/reproducing position respect to an information recording layer of the disk.

It should be noted that FIG. 1 is a state diagram while the tray 1 is moved, in which a part of an internal structure is omitted for easier understanding.

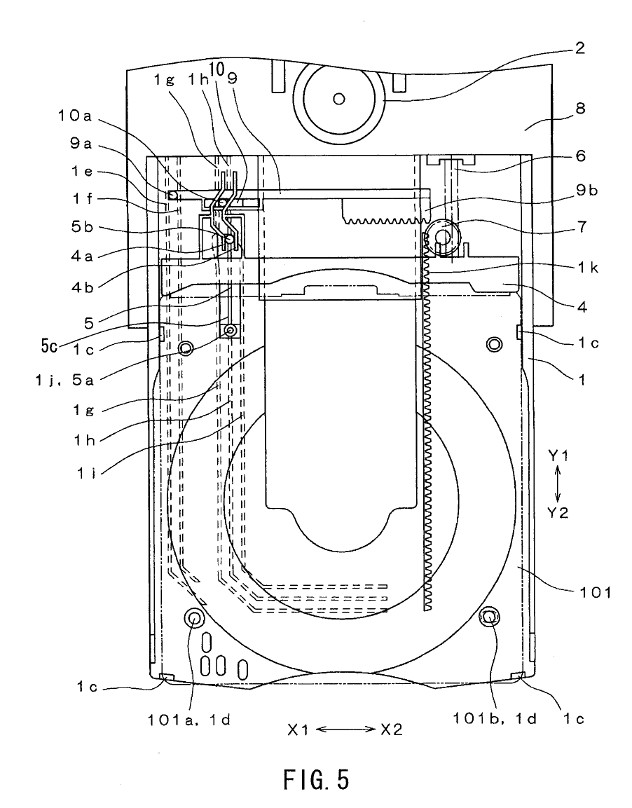

A main face 1a is structured on the tray 1, two mounting faces 1b for mounting the BD cartridge 102 are provided on the main face 1a, and four mounting faces 1c (see FIG. 5) for the RAM cartridge 101 are provided.

Further, on the tray 1, two positioning pins 1d serving as disc cartridge guides are provided. Each of the positioning pins 1d is inserted into a reference hole 101a and a sub-reference hole 101b that are provided in the RAM cartridge 101 shown in FIG. 2. Similarly, each of the positioning pins 1d is inserted into a reference hole 102a and a sub-reference hole 102b that are provided in the BD cartridge 102 shown in FIG. 3.

That is, the positioning pin 1d can determine both of the positions of the RAM cartridge 101 and the BD cartridge 102. The reason for this is because reference hole diameters D101 and D102, sub-reference hole widths E101 and E102 and intervals X101 and X102 between the reference holes and the sub-reference holes are substantially equal, respectively.

Moreover, an inclined portion is formed on a tip of the positioning pin 1d. As shown in FIG. 1, the inclined portion is inclined such that a side of the mounting position (a Y2 side) in a transferring direction of the tray 1 by the transferer is close to the mounting face 1a of the tray 1. This aims to improve the insertability of the cartridge.

In the example illustrated in FIG. 1, an incline of the inclined portion of the positioning pin 1d accords with an incline of the pin cover 21, but the structure is not limited to this. For example, in the case of not using the pin cover 21, if an inclining direction of the inclined portion of the positioning pin 1d is a direction (a direction of Y1, Y2) in which the cartridge is inserted or ejected, it is more effective for improving the insertability of the cartridge.

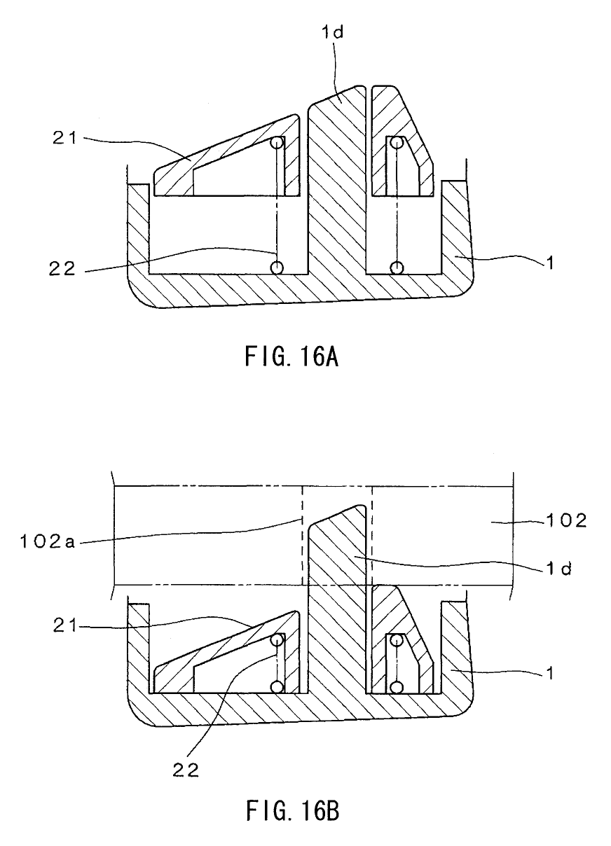

On a periphery of each of the positioning pins 1d, the pin cover 21 is provided. A detailed explanation will be provided below with reference to FIGS. 16A and 16B, but the pin cover 21 is biased in a direction of protruding with respect to the tray 1 by a spring 22 (FIGS. 16A and 16B), and can be raised and lowered by extension and contraction of the spring 22. For example, in a state of FIG. 1, when mounting the BD cartridge 102, the pin cover 21 is moved in a direction of burying with respect to the tray 1, as shown in FIG. 16B. Further, the pin cover 21 also can function as a guide in the case of mounting the simplex of the disk 100 on the tray 1.

Moreover, as described below with reference to FIGS. 16A and 16B, the pin cover 21 is buried when the RAM cartridge 101 and the BD cartridge 102 are mounted. In this case, it is structured such that a height of a top face of the pin cover 21 when the BD cartridge 102 is in contact is not buried to be lower than a height that is equal to a base face 1b. Thus, the pin cover 21 also can control the height of the BD cartridge 102.

Incidentally, a distance from the disk 100 accommodated in the RAM cartridge 101 to a lower face of the RAM cartridge is shorter than a distance from the disk 100 accommodated in the BD cartridge 102 to a lower face of the BD cartridge 102. Thus, it is necessary to change a height of the mounting face of the tray 1 for each cartridge. That is, an individual mounting face is required for each cartridge, and the height of the mounting face 1c from the main face 1a is larger than that of the mounting face 1b (about 0.8 mm).

Concave portions 1m and 1n are mounting portions of the disk 100 in a bare state of not being accommodated in any cartridge and a disk with a diameter of 8 cm, respectively, and centers of these mounting portions 1m and 1n substantially coincide with the center of the disk 100 accommodated in the RAM cartridge 101 when the RAM cartridge 101 is mounted.

As described below in detail, according to this structure, transferring distances when accommodating the tray 1 on a side of the mechanical pedestal 8 can be the same, in both of the case of mounting the disk in the bare state on the tray 1 and the case of mounting the RAM cartridge 101.

Moreover, it also is possible that the centers of the mounting portions 1m and 1n substantially coincide with the center of the disk 100 accommodated in the BD cartridge 102, when the BD cartridge 102 is mounted. According to this structure, the transferring distances when accommodating the tray 1 on the side of the mechanical pedestal 8 can be the same, in both the case of mounting the disk in the bare state on the tray 1 and the case of mounting the BD cartridge 102.

Incidentally, a distance between a positioning hole of the RAM cartridge 101 and the center of the disk 100 (Y101 in FIG. 2) is smaller than a distance between a positioning hole of the BD cartridge 102 and the center of the disk 100 (Y102 in FIG. 3).

Thus, in the case where the centers of the mounting portions 1m and 1n substantially coincide with the center of the accommodated disk 100 when mounting the RAM cartridge 101, the positions of the centers of the mounting portions 1m and 1n are closer to a front face side (a Y2 side) of the tray 1. This structure facilitates mounting the disk in the bare state on the tray 1.

On a lower face of the tray 1, three shaft guiding cam tracks are provided, which are constituted of ribs of slide rack guiding cams 1e and 1f, and slider guiding cams 1g, 1h and 1i.

Moreover, a shaft portion 1j is provided on the tray 1, and is inserted into a hole portion 5a of a track selecting lever 5 such that the track selecting lever 5 can be rotated. In the track selecting lever 5, a slider guiding wall 5c that exists on an extension of the slider guiding cam 1h, and a shaft portion 5b that is engaged with a cartridge detecting slider 4 are provided.

The cartridge detecting slider 4 is structured on the tray 1 such that it can be moved in the directions of Y1 and Y2, and is biased in the direction of Y2 by a compression spring 6. The cartridge detecting slider 4 has a cam track for guiding the position of the shaft portion 5b of the track selecting lever 5, which is constituted of lever guiding cams 4a and 4b. Moreover, a curved-face concave portion 4c is formed in the cartridge detecting slider 4, and functions as an engagement face when mounting the simplex of the disk 100 on the tray 1.

As described below in detail, a moving distance of the cartridge detecting slider 4 when mounting the cartridge differs depending on a size and a form of the outside shape of the cartridge. According to the difference of this moving distance, an engagement relationship between the shaft portion 5b of the track selecting lever 5 and the lever guiding cams 4a and 4b of the cartridge detecting slider 4 differs. Thereby, the cartridge detecting slider 4 switches the position of the track selecting lever 5 in accordance with the outside shape of the cartridge. Therefore, the cartridge detecting slider 4 is a detector for detecting the outside shape difference of the cartridge.

In FIG. 1, the cartridge detecting slider 4 is shown on an upper side relative to an original position thereof for easier recognition, and the original position where the cartridge detecting slider 4 actually is located is indicated by alternate long and short dashed lines. Also, the shaft portion 5b of the track selecting lever 5 that is engaged with the cartridge detecting slider 4 shown on the upper side is illustrated. The illustration of this shaft portion 5b is added for convenience in order to help the recognition of the engagement relationship. A part of FIG. 1 illustrates the entire shaft portion 5b, which shows an actual position of the shaft portion 5b.

On the mechanical pedestal 8, a slide rack 9 is structured such that it can be moved in directions X1 and X2, and also can be engaged with the gear 7. Moreover, a shaft portion 9a of the slide rack 9 is guided by the slide rack guiding cams 1e and 1f. A positioning slider 10 is structured in the slide rack 9 such that it can be moved in the directions of X1 and X2, and is biased by a spring 11 in the direction of X1, so that a shaft portion 10a of the positioning slider 10 is guided by the slider guiding cams 1g, 1h and 1i.

As described below in detail, in the present embodiment, the tray 1 by changing the engagement relationship between a member on the tray 1 side and a member provided in a pedestal portion that accommodates the tray 1 is provided.

More specifically, based on the detection result obtained by the cartridge detecting slider 4 as described above, the engagement relationship between the cam track formed on the tray 1 side and the member on the mechanical pedestal 8 side is switched, so that the position of the track selecting lever 5 is switched. As a result, it is determined whether the shaft portion 10a of the positioning slider 10 is guided by the cam track between the guiding cams 1g and 1h or the cam track between the guiding cams 1h and 1i.

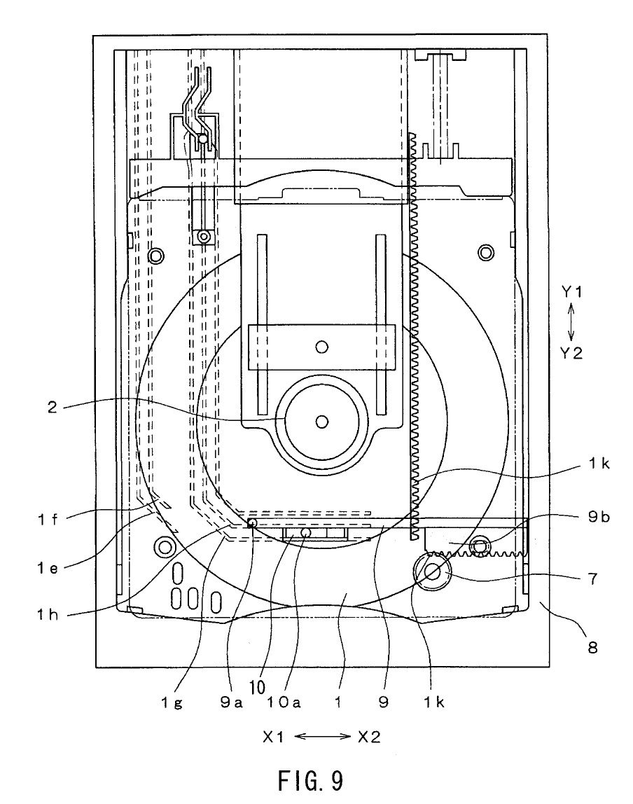

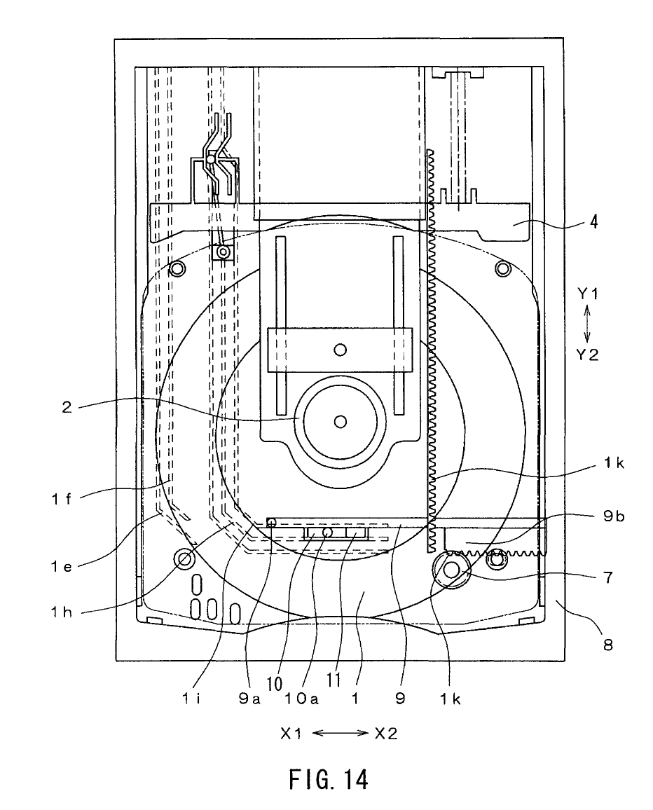

In a state where the transfer of the tray 1 is completed, the transferring distance of the tray 1 differs between: when the shaft portion 10a is on the cam track between the guiding cams 1g and 1h as shown in FIG. 9; and when the shaft portion 10a is on the cam track between the guiding cams 1h and 1i as shown in FIG. 14.

Thus, at least the track selecting lever 5, the shaft portion 10a of the positioning slider 10, and guiding cams 1g, 1h and 1i constitute the transferring distance changer that can change the transferring distance of the tray based on the detection result of the cartridge detecting slider 4, and can transfer the center of each disk accommodated in each cartridge to a substantial center of the motor.

Reference numeral 2 denotes the motor, which is engaged with the disk 100 so as to be rotated. The motor 2 is provided on the mechanical pedestal 8 and combined with the traverse unit 3. The traverse unit 3 is a head for recording information onto the information recording layer of the disk 100 and/or reproducing the information of the information recording layer.

The motor 2 is structured to be moved away downwards when the motor 2 in accordance with the slide rack 9 after the tray 1 is moved. Since this is a common structure, detailed descriptions and explanations are omitted herein.

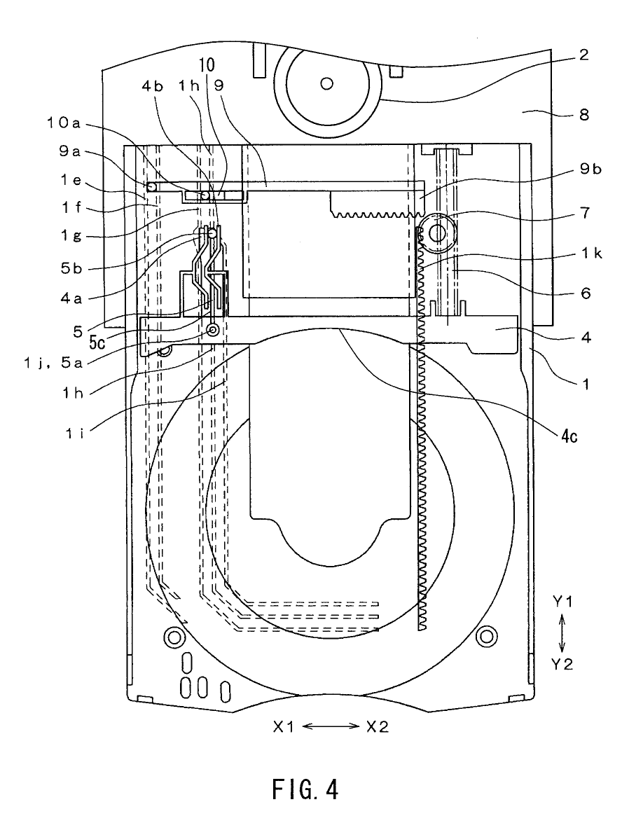

Next, operations of the above-described structure will be described with reference to the figures. FIG. 4 is a plan view showing a state where an operation of the tray 1 from the mechanical pedestal 8 in an ejecting direction is completed. This figure shows a state where the cartridge or the disk can be mounted on the tray 1 or can be ejected therefrom. Herein, the rack 1k and the slide lack 9 are provided on a rear face of the tray 1, but outside shapes thereof are shown in solid lines for easier recognition of the illustration. This also applies to the respective figures described below. Moreover, other than this, some parts are illustrated in solid lines that should be shown in broken lines in the respective figures besides FIG. 4, which is intended for convenience of illustration.

Here, when mounting the disk with a diameter of 8 cm, since the disk of 8 cm is not in touch with the cartridge detecting slider 4, the cartridge detecting slider 4 is not moved. Moreover, when mounting the disk 100, a curved face 4c of the cartridge detecting slider 4 is engaged directly with the outside shape of the disk 100.

Thus, in the state of FIG. 4, the cartridge detecting slider 4 is pressed by the compression spring 6 so as to be positioned at most frontward with respect to the tray 1, and this state is the same as those in the case of mounting the disk 100 and the disk of 8 cm.

The shaft portion 5b of the track selecting lever 5 is positioned by being inserted into a cam track between the lever guiding cams 4a and 4b. Thereby, the slider guiding wall 5c of the track selecting lever 5 is positioned on an extension of the slider guiding cam 1h of the tray 1.

As shown in FIG. 4, if the slider guiding wall 5c is positioned on the extension of the guiding cam 1h without being inclined, even when the position of the cartridge detecting slider 4 differs, the transferring distance of the tray 1 by a subsequent operation becomes the same. Thus, when mounting the disk 100, the disk 100 may press the cartridge detecting slider 4 so as to move it, as long as the slider guiding wall 5c is not inclined.

The slide rack 9 is structured such that the shaft portion 9a is inserted between the slide guiding cams 1e and 1f of the tray 1, and the position thereof in the directions of X1 and Y1 is fixed and not moved. The positioning slider 10 is structured such that the shaft portion 10a is inserted between the slider guiding cams 1g and 1h, and the position thereof in the directions of X1 and Y1 is fixed and not moved similarly.

The operation when the tray 1 is moved from this state in the direction of Y1 is the same as the operation when the disk 100 or the disk of 8 cm is mounted, and the operation when the RAM cartridge 101 is mounted. Thus, the operations will be described in the state where the RAM cartridge is mounted.

FIG. 5 is a plan view when the tray 1 is in the ejecting state and the RAM cartridge 101 is mounted. For easier understanding of the illustration, the outside shape of the RAM cartridge 101 is shown in alternate long and two short dashes lines. This will be applied also to the respective figures below.

The reference hole 101a and the sub-reference hole 101b of the RAM cartridge 101 are positioned in a plane direction by being engaged with the pin 1d, respectively, and are positioned in a height direction by being in touch with the mounting face 1c. At this time, the cartridge detecting slider 4 is moved in the direction of Y1 by the RAM cartridge.

In this moving process, the lever guiding cams 4a and 4b that are combined with the cartridge detecting slider 4 also are moved in the direction of Y1. As shown in FIGS. 4 and 5, each of the lever guiding cams 4a and 4b are provided with two inclined faces having transferring direction that are reverse to each other. Thus, the shaft portion 5b of the track selecting lever 5 is once rotated around the shaft portion 1j as a center in tie direction of X1 along the cam track between the lever guiding cams 4a and 4b, and subsequently is rotated in the direction of X2 so as to return to an initial state.

That is, between the state of FIG. 4 and the state of FIG. 5, a position of the slider guiding wall 5c of the track selecting lever 5 is the same, and is on the extension of the slider guiding cam 1h of the tray 1. Moreover, the relationship between the slide rack 9 and the positioning slider 10 is the same as that before the RAM cartridge 101 is mounted. Here, when driving the DC motor (not illustrated) so as to rotate the gear 7 clockwise, the tray 1 starts to be moved in the direction of Y1, because the rack 1k of the tray is engaged with the gear 7.

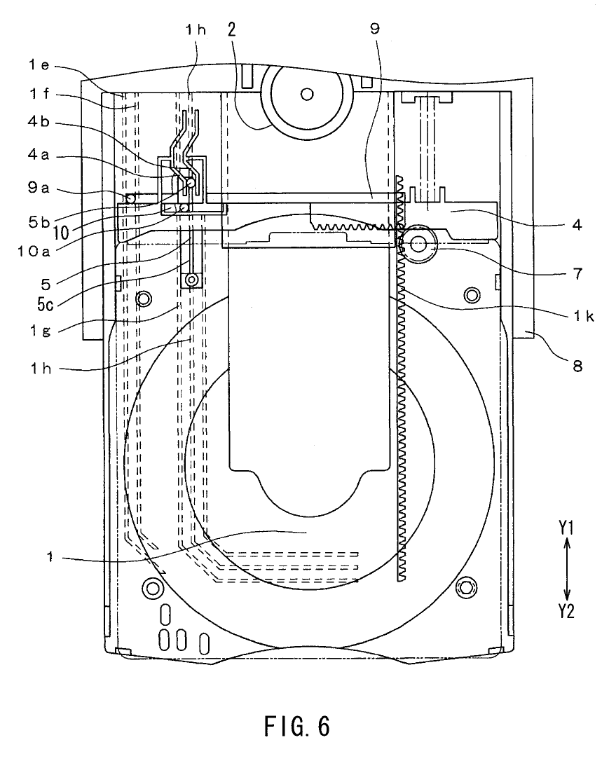

FIG. 6 is a state diagram showing that the tray 1 is moved slightly in the direction of Y1. Herein, the shaft portion 10a of the positioning slider 10 is guided by the slider guiding cam 1g and the slider guiding wall 5c of the track selecting lever 5. Moreover, as explained above, the slider guiding wall 5c is positioned on the extension of the slider guiding cam 1h. Thus, in the state where the position of the positioning slider 10 in the directions of X1 and X2 is not changed, the tray 1 continues to be moved in the direction of Y1.

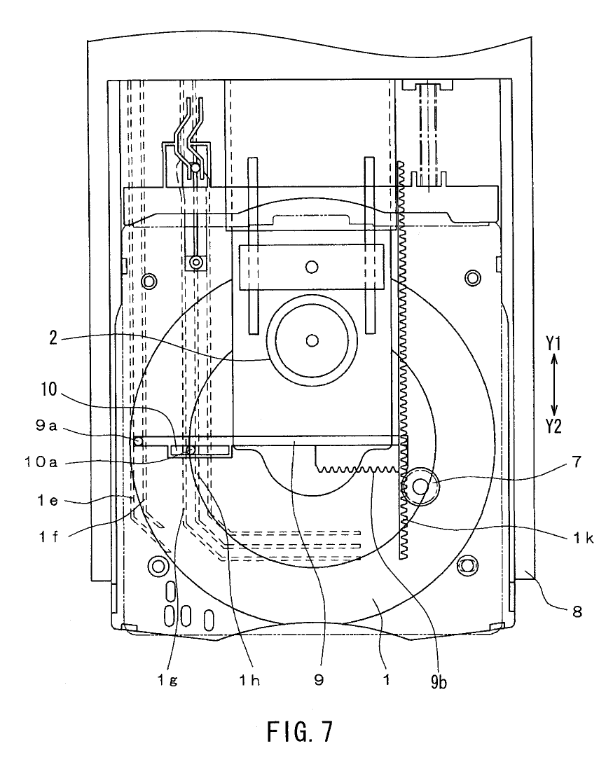

FIG. 7 shows a state where the tray 1 is moved further in the direction of Y1. It is realized that, in this state, the slide rack 9 and the positioning slider 10 have a positional relationship in the directions of X1 and X2 that is the same as that in the state of FIG. 6.

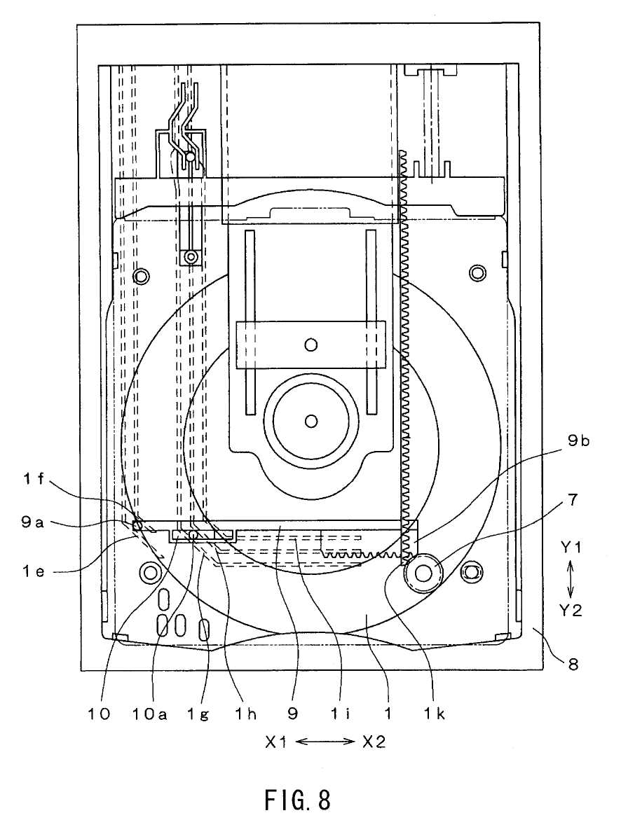

FIG. 8 shows a state where the tray 1 is moved further in the direction of Y1, and the slide rack 9 starts to be moved in the direction of X2. The shaft portion 9a of the slide rack 9 is guided by the slide rack guiding cams 1e and 1f. In the position of the shaft portion 9a, the slide rack guiding cams 1e and 1f are inclined. Thus, when the tray 1 is moved in the direction of Y1, the shaft portion 9a is pressed in the direction of X2, and the slide rack 9 starts to be moved in the direction of X2.

Moreover, the shaft portion 10a of the positioning slider 10 is guided by the slider guiding cams 1g and 1h. Since the slider guiding cams 1g and 1h also are provided with inclines that are similar to those of the guiding cams 1e and 1f, the positioning slider 10 starts to be moved in the direction of X2. Here, it should be noted that inclined angles of the slide rack guiding cams 1e and 1f are substantially equal to inclined angles of the slider guiding cams 1g and 1h. Thus, a relative positional relationship between the slide rack 9 and the positioning slider 10 is almost the same, and they are moved together in the direction of X2 while maintaining this state.

As this movement proceeds, the rack 9b of the slide rack 9 starts to be engaged with the gear 7. Thereafter, when it proceeds by some distance, the engagement of the rack 1k of the tray 1 with the gear 7 is released. Subsequently, the shaft portion 9a and the shaft portion 10a press the inclined faces of the respective guiding cams in the direction of Y1 by a force caused by the movement of the slide rack 9 in the direction of X2, whereby the tray 1 is moved further in the direction of Y1.

FIG. 9 shows a state where the movement of the tray 1 is completed, and a signal to the disk 100 can be recorded and reproduced. The slider guiding cams 1g and 1h have regions that are structured to be extended in the directions of X1 and X2. In the process proceeding from the state of FIG. 8 to the state of FIG. 9, the shaft portion 10a of the positioning slider 10 enters into the region. In this state, the tray 1 is not moved in the directions of Y1 and Y2, and the positioning is completed. The positioning slider 10 is prevented from being moved by a certain distance (about 4 mm to 7 mm) or more with respect to the slide rack 9. At the time of completing the positioning of the tray 1, the center of the disk 100 is at the position of the substantial center (a rotational axis) of the motor 2.

Moreover, the engagement of the slide rack guiding cams 1e and 1f with the shaft portion 9a is no longer necessary when the shaft portion 10a directions of X1 and X2. Thus, at this time, the guiding cams 1e and 1f are broken off so as to release the engagement of the guiding cams 1e and 1f with the shaft portion 9a. After releasing the engagement of the guiding cams 1e and 1f with the shaft portion 9a, the shaft portion 9a is not guided by other cams as well.

Incidentally, the shaft portion 9a appears to cross the slider guiding cams 1g and 1h in a plane, but a position of an upper face of the shaft 9a is lower than positions of lower faces of the slider guiding cams 1g and 1h, and thus is not in touch with (does not cross) them.

Moreover, a moving distance of the slide rack 9, after the shaft portion 10a is engaged with the portions where the slider guiding cams 1g and 1h are extended in the directions of X1 and X2, appears to be too large, although detailed explanation thereof is omitted here. However, the reason for this is because operations to raise the motor 2 and the traverse unit 3 and to engage the disk 100 with the motor 3 so as to make it possible to record and reproduce the signal to the disk 100 are carried out in accordance with each other.

It should be noted that the operations described above are reversible, and it can be operated similarly also in the case of ejecting the tray 1.

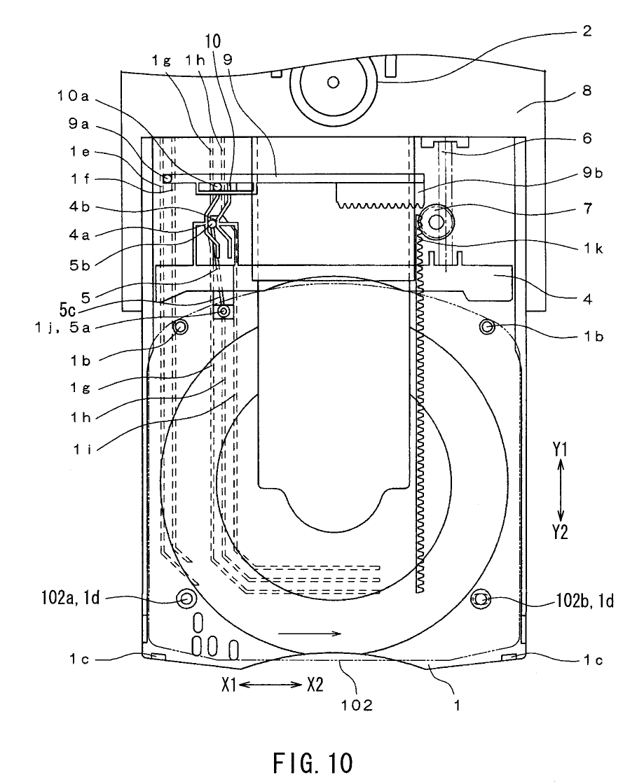

Next, operations when mounting the BD cartridge 102 onto the tray 1 will be described. FIG. 10 shows a state of mounting the BD cartridge 102 when ejecting the tray 1. For easier understanding of the illustration, the outside shape of the RAM cartridge 101 is shown in alternate long and two short dashes lines. This also is applied to the respective figures described below.

The reference hole 102a and the sub-reference hole 102b of the BD cartridge 102 respectively are engaged with the pin 1d so as to be positioned in the plane direction, and are in touch with the mounting face 1b so as to be positioned in the height direction.

Thus, at the time of mounting the BD cartridge 102 onto the tray 1, the positioning in the plane direction and the positioning in the height direction are completed. This is the same as the case of mounting the RAM cartridge 101.

The distance (see Y101 in FIG. 2 and Y102 in FIG. 3) between the center of the disk 100 accommodated in the cartridge and the cartridge positioning hole differs between when mounting the BD cartridge 102 and when mounting the RAM cartridge 101. Thus, in the case of mounting the BD cartridge 102, in order to allow the center of the disk and the rotational axis of the motor to substantially coincide with each other, an adjusting operation that is different from that in the case of mounting the RAM cartridge 101 is required. Description of operations when mounting the BD cartridge 102 onto the tray 1, mainly based on the above-described operation, will be provided below.

As described above, at the time when the positioning of the BD cartridge 102 in the plane direction and the height direction is achieved, the cartridge detecting slider 4 is moved in the direction of Y1 by the BD cartridge 102.

However, since the RAM cartridge 101 and the BD cartridge have the different outside shapes, the moving distance when mounting the BD cartridge 102 is smaller than the moving distance when mounting the RAM cartridge 101. Due to this movement, the shaft portion 5b of the track selecting lever 5 is moved around the shaft portion 1j in the direction of X1 along the cam track between the lever guiding cams 4a and 4b so as to be positioned.

As a result, the track selecting lever 5 is in a state of connecting the slider guiding cams 1g and 1h like railroad points. Incidentally, even in this case, the relationship between the slide rack 9 and the positioning slider 10 is the same as that in the case where the BD cartridge 102 is not mounted.

Here, similarly to the case of mounting the RAM cartridge 101, when tray 1 starts to be moved in the direction of Y1, because the rack 1k of the tray 1 is engaged with the gear 7.

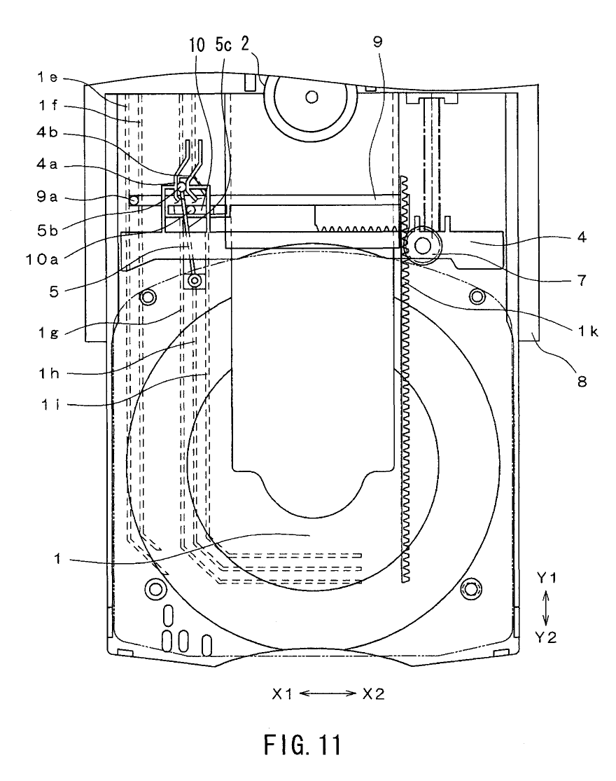

FIG. 11 is a state diagram showing that the tray 1 is moved slightly in the direction of Y1. Herein, the shaft portion 10a of the positioning slider 10 is guided by the slider guiding wall 5c of the track selecting lever 5. Here, since the slider guiding wall 5c is inclined with respect to the directions of Y1 and Y2 in which the tray is moved, while the shaft portion 10a is moved along the slider guiding wall 5c, the positioning slider 10 is moved in the direction of X2. Further, when the tray 1 is moved in the direction of Y1, the shaft portion 10a is guided by the slider guiding cams 1h and 1i.

However, the shaft portion 9a of the slide rack 9 is guided by the slide rack guiding cams 1e and 1f. Thus, the slide rack 9 is not moved in the direction of X2, but the positioning slider 10 is relatively moved in the direction of X2 with respect to the slide rack 9.

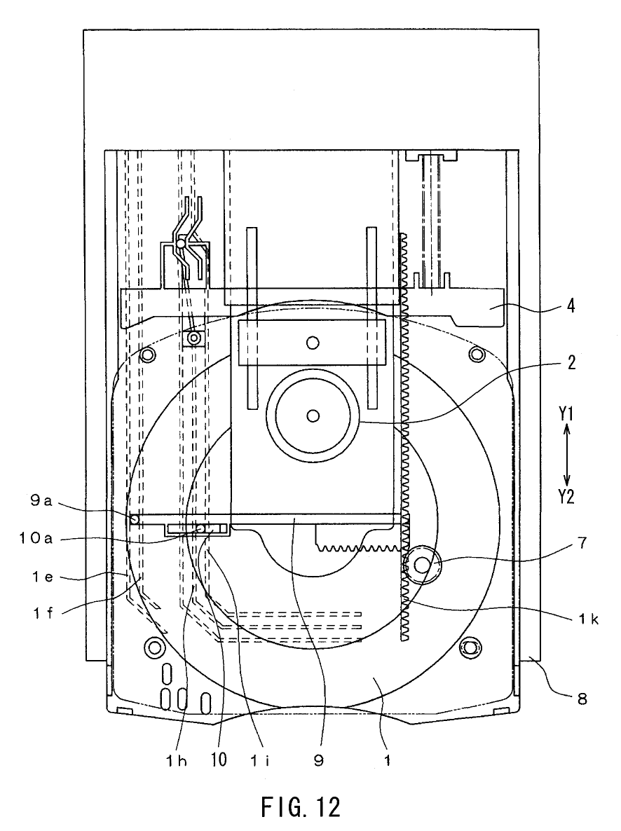

FIG. 12 shows a state where the tray 1 is moved further in the direction of Y1. As shown in this figure, it is seen that the shaft portion 10a is guided by the slider guiding cams 1h and 1i.

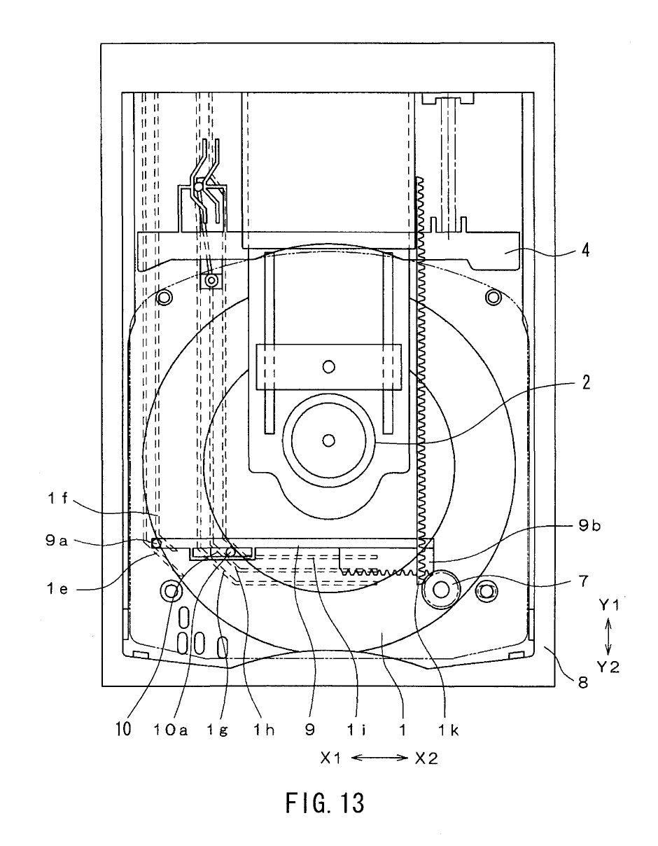

FIG. 13 shows a state where the tray 1 is moved further in the direction of Y1, and the slide rack 9 starts to be moved in the direction of X2. The shaft portion 9a of the slide rack 9 is guided by the slide rack guiding cams 1e and 1f. In the position of the shaft portion 9a, the slide rack guiding cams 1e and 1f are inclined. Thus, when the tray 1 is moved in the direction of Y1, the shaft portion 9a is pressed in the direction of X2, and the slide rack 9 starts to be moved in the direction of X2.

Moreover, the slider guiding cams 1h and 1i also are provided with inclines that are similar to those of the guiding cams 1e and 1f. Thus, by being guided by the slider guiding cams 1h and 1i, the shaft portion 10a is moved in the direction of X2, and the positioning slider 10 also is moved in the direction of X2.

This working example adopts a cam structure, in which the slider 10 is moved in the direction of X2 slightly faster in the case of mounting the BD cartridge 102 than in the case of mounting the RAM cartridge 101. Thus, an interval between the shaft portion 9a of the slide rack 9 and the shaft portion 10a of the positioning slider 10 becomes slightly wider than that in the state of FIG. 12, which provides a movement allowance for enabling the movement.

Need less to say, it also is possible to achieve the cam structure that operates the positioning slider 10 in the direction of X2 at a timing that is same as that of the operation in the case of mounting the RAM cartridge 101, by changing a width of the slider guiding cam 1h.

Moreover, the engagement of the rack 1k of the tray 1 with the gear 7 is released, and subsequently, the tray 1 is moved in the direction of Y1 by a force caused by the movement of the slide rack 9 in the direction of X2. This operation is the same as the operation when mounting the RAM cartridge 101 described above. FIG. 14 shows a state where the movement of the tray 1 is completed, and the recording/reproducing of the signal with respect to the disk 100 becomes possible.

The slider guiding cam 1h and the slider guiding cam 1i have regions that are structured to be extended in the directions of X1 and X2. In the process proceeding from the state of FIG. 13 to the state of FIG. 14, the shaft portion 10a of the positioning slider 10 enters into the region. More specifically, in the state of FIG. 13, the positioning slider 10 is biased in the direction of X1 by the spring 11. Thus, even if the slide rack 9 is moved in the direction of X2, the slider 10 is not moved together with the slide rack 9 in the direction of X2, until the spring 11 is fully extended and an end of the slider 10 on the side of the direction of X1 is in touch with the slide rack 9.

By moving the slide rack 9 and the positioning slider 10 together in the direction of X2, the shaft portion 10a of the positioning slider 10 enters between the slider guiding cam 1h and the slider guiding cam 1i. In this state, even if the slide rack 9 and the positioning slider 10 are moved together in the direction of X2, the tray 1 is not moved in the directions of Y1 and Y2, thereby completing the positioning. At the time of completing the positioning of the tray 1, the center of the disk 100 is at the position of the substantial center (the rotational axis) of the motor 2.

It should be noted that, similarly to the case of mounting the RAM cartridge 101, the operations described above are reversible, and it can be operated similarly also in the case of ejecting the tray 1.

Here, in the state of FIG. 14, the spring 11 is fully extended and the end of the slider 10 on the side of the direction of X1 is in touch with the slide rack 9. In this state, when carrying out the reverse operation for ejecting the tray 1, the slider 10 is moved together with the slide rack 9 in the direction of X1. When this movement proceeds, the shaft portion 9a of the slide rack 9 is in touch with the slide rack guiding cam 1e, the shaft portion 10a of the slider 10 is on the inclined portions of the guiding cams 1h and 1i.

After that, while the inclined portions of the guiding cams 1h and 1i are moved along the shaft portion 10a, in accordance with the rotation of the gear 7 that is engaged with the rack 1k, the tray 1 is moved in the direction of Y2.

On the other hand, also in the state of FIG. 14, if the positioning slider 10 remains in the state of being moved in the direction of X2 similarly to the state of FIG. 13, when the shaft portion 9a of the slide rack 9 is in touch with the slide rack guiding cam 1e, the shaft portion 10a of the slider 10 is in the portion where the guiding cam 1i is extended horizontally in the directions of X1 and X2. In this state, the movement of the tray 1 in the direction of Y2 is prevented by the shaft portion 10a, thus causing inoperablity. That is, the spring 11 also has a function to prevent the inoperablity in the case of ejecting the tray 1.

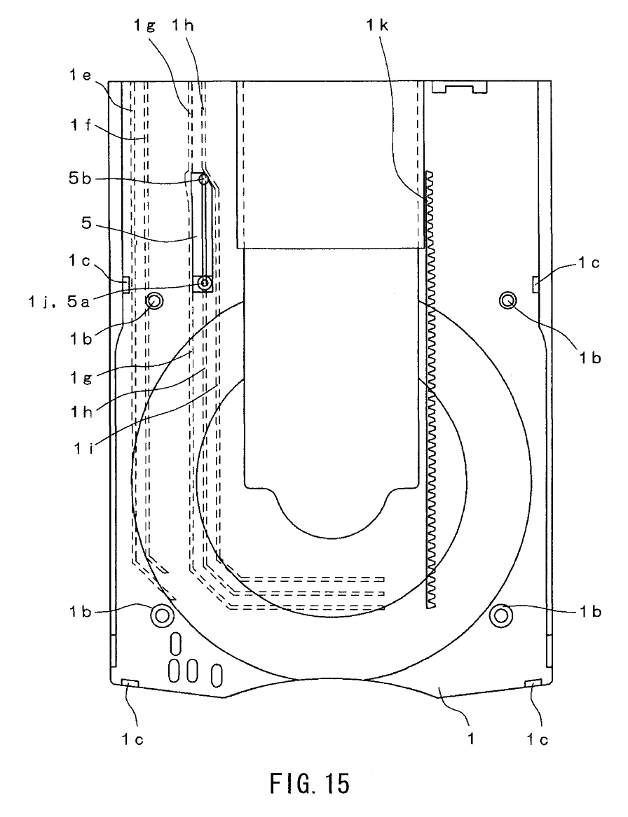

FIG. 15 is a view showing the state with the cartridge detecting slider 4 removed for easy recognition of the shape of the tray 1. It is realized that the slider guiding cam 1h ends its shape halfway, where the track selecting switch the cam tracks. Moreover, it is realized that the slider guiding cam 1i is connected with the slider guiding cam 1h around this part, thereby providing a guiding function.

It should be noted that the rack 1k is located on the rear face of the tray 1, but an outside shape of the rack 1k is illustrated in solid lines, similarly to the other respective figures.

By the way, as shown in the respective figures such as FIGS. 1 and 4, the lever guiding cam 4a and the lever guiding cam 4b of the cartridge detecting slider 4 are formed to be thin and have a spring-like function, and are structured so as to be connected with a body portion of the cartridge detecting slider 4.

For example, in a state where the BD cartridge 102 is mounted on the tray 1, this aims to prevent the inoperablity of the tray 1 caused in the case of removing the cartridge from the tray 1 compulsorily, from the time when the tray 1 starts the operation in the direction of Y1 until completing the positioning operation, alternatively, during the operation in the direction of Y2 from the state of the positioning of the tray 1.

More specifically, for example, in the state of FIG. 12, when the BD cartridge 102 is removed from the tray 1 intentionally, the cartridge detecting slider 4 is moved in the direction of Y2 by repulsion of the compression spring 6 so as to return to the state of FIG. 4. At this time, the track selecting lever 5 is rotated, so that the position of the track selecting lever 5 is switched to select the track when mounting the RAM cartridge 101 as shown in FIG. 5.

Whereas, as shown in FIG. 12, since the shaft portion 10a is between the guiding cam 1h and the guiding cam 1i, when the tray 1 is moved in the direction of Y2 so as to be ejected, the shaft portion 10a hits the track selecting lever 5. In this case, if the lever guiding cam 4a and the lever guiding cam 4b are rigid bodies, the operation of the tray 1 cannot be achieved.

Thus, by forming the lever guiding cam 4a and the lever guiding cam 4b of, for example, plate springs of a resin so as to provide an allowance for the track selecting lever 5 to slip through, the operation of the shaft portion 10a is not prevented. According to this structure, even when carrying out irregular manipulations including the case of mounting the cartridge during the operation of the tray 1, the ejecting operation of the tray 1 can be achieved.

Next, the positioning pin cover 21 will be explained with reference to FIGS. 16A and 16B. FIGS. 16A and 16B are views showing cross sections of the positioning pin 1d and the positioning pin cover 21. FIG. 16A shows a state where the cartridge is not mounted. The positioning pin cover 21 is in a state of being biased upwards by the spring 22, and covers the positioning pin 1d such that the positioning pin 1d does not protrude from the positioning pin cover 21.

Thereby, when mounting the disk 100 only, an effect of preventing the damage to the disk 100 caused by being in touch with the positioning pin 1d that is the rigid body can be obtained.

Moreover, a structure where the pin cover 21 is not used, and a structure where a height of the positioning pin 1d is increased so as to secure a fitting distance between the cartridge and the positioning pin 1d sufficiently, and the positioning pin 1d protrudes from the pin cover 21 such that the cartridge is not likely to be detached from the positioning pin 1d are considered. In this case, by using different materials for the positioning pin 1d and the tray 1 as different members, it is effective to prevent the damage of the disk 100. For example, as the material for the positioning pin 1d, a fluorocarbon resin, a silicone resin, a polyacetal and the like are exemplified.

In addition, the positioning pin cover 21 can function also as a guide for the outside shape when mounting the disk 100 into a groove portion 1m. Thus, the positioning pin cover 21 is structured such that a part of its contour is positioned on a slight outside from the outer diameter of the disk 100. Moreover, since the tray is a visible member and requires the designability, this structure has an effect for covering the positioning pin 1d such that it does not stand being exposed.

Moreover, in the light of the designability, as shown in FIG. 1, the pin cover 21 is preferably disposed so as to be extended in a radial manner in a substantial diameter direction of a circle whose center coincides with the center of the disk (centers of the groove portions 1m and 1n) when mounting the simplex of the disk. Further, as shown in FIG. 1, the pin cover 21 may form the inclined face so as to be closer to the mounting face 1a of the tray 1 as being extended in the radial manner, and the inclining direction of the inclined portion at the tip of the positioning pin 1d may be substantially the same as the inclining direction of the inclined face of the pin cover 21.

FIG. 16B shows a state where the BD cartridge 102 is mounted. The positioning pin 1d is inserted into the reference hole 102a of the BD cartridge 102.

The force of the spring 22 is set to be weak so that the spring 22 is compressed by a weight of the BD cartridge 102. Thus, the positioning pin cover 21 is guided by the positioning pin Id, and is buried downward of the main face 1a of the tray 1.

Moreover, it is structured such that the buried amount of the positioning pin cover 21 does not become larger than a certain amount by allowing the lower face of the positioning pin cover 21 to be in touch with the tray 1, and is structured such that a mounting height of the BD cartridge 102 is determined via the positioning pin cover 21. Moreover, in the case of mounting the RAM cartridge 101 that requires to increase the height of the mounting face by the BD cartridge 102, since the height is determined by the mounting face 1c, the lower face of the positioning pin cover 21 is not in touch with the tray 1 and remains floating.

In the present embodiment, it is structured to switch between two positions including: a position for positioning the BD cartridge 102; and a positioning in the case of mounting only a bare disk such as the disk 100 is the same as the position for positioning the RAM cartridge 101. However, the structure is not limited to this, and the position for positioning in the case of mounting only the bare disk also may be the position for positioning the BD cartridge 102.

Moreover, it also may be structured so that the position for positioning in the case of mounting only the bare disk such as the disk 100 is another position for positioning, and three positions for positioning are provided, and further, four or more positions for positioning may be provided.

In the present embodiment, it is structured to be able to mount the two kinds of cartridges having different shapes and to switch the positions for positioning the tray, but it also is possible to structure to be able to mount one kind of cartridge and the bare disk and to switch the positions for positioning in the respective cases.

Moreover, in the present embodiment, it is structured to switch the positions for positioning the tray 1 so as to position the cartridges having the different shapes. However, the structure is not limited to this, and may be applied to, for example, so-called a slot-in system having, inside the disk apparatus, a cartridge guide in which the tray is not used and the cartridge can be inserted directly. In this case, it may be structured to switch the positions for positioning, by enabling movement of the cartridge guide in a cartridge inserting direction.

Moreover, in the present embodiment, the positioning pin is fixed on the tray, but a raising/lowering pin that can position the cartridge also may be used.

Moreover, in the present embodiment, the positioning of the cartridge in the plane direction is performed by the positioning pin on the tray, but a guide shape for guiding the outside shape of the cartridge also may be provided.

Moreover, in the present embodiment, the two position pins as a pair are provided, but only one positioning pin may be provided in combination with the guide shape for guiding the outside shape of the cartridge.

Moreover, in the present embodiment, it is structured to bury the positioning pin cover being guided by the positioning pin, but may be structured to guide by rotating around the rotational axis as a center or by providing other guiding pin, as long as it is possible to bury the positioning pin cover while keeping off from the positioning pin.

Moreover, in the present embodiment, the tip of the positioning pin guide is inclined, but may not be inclined unless losing the mountability at the time of mounting the cartridge.

Moreover, in the present embodiment, the positioning pin except for its tip is structured to be a parallel pin, but may be structured to be a stepped pin, a conical pin or a combination thereof, as long as it can position with precision in a state where the cartridge is seated.

Moreover, in the present embodiment, it is structured such that the centers of the concave portions 1m and 1n substantially coincide with the center of the disk 100 accommodated in the RAM cartridge 101 when the RAM cartridge 101 is mounted.

The reason for substantially coincide is because the final positioning of the disk 100 is completed when being mounted on the motor 2. That is, in the state of being mounted on the tray 1, even if both of the centers do not necessarily coincide with each other, the disk 100 can be positioned precisely relative to the motor 2, while the motor 2 receives the disk 100.

Moreover, as described below, there also is a case where the center of the concave portions 1m and 1n are displaced from the center of the disk 100 in the cartridge in the state of being mounted the cartridge, considering the height difference of the disk 100.

More specifically, in the case where the traverse unit 3 is raised and lowered being rotated, the center of the concave portions 1m and 1n may be displaced by about 0.2 mm to 0.5 mm from the center of the RAM cartridge 101 to an opposite side of a rotational fulcrum of the traverse unit 3. Thereby, when mounting the simplex of the disk 100, the disk 100 can be passed between the motor and the tray with precision.

This aims to optimize in accordance with a difference of the track at the time of raising and lowering the disk 100 due to the height difference, which is generated because the height of the disk 100 when the simplex of the disk 100 is placed is smaller than the height of the disk 100 in the RAM cartridge 101.

Moreover, the tray 1 is structured such that the center of the simplex of the disk 100 and the center of the disk 100 accommodated in the cartridge are transferred to the substantial center of the motor. In this case, the reason for substantial center is because the final positioning of the disk 100 is completed when being mounted on the motor 2, similar to the reason for the substantial coincidence when the RAM cartridge 101 is mounted.

### INDUSTRIAL APPLICABILITY

The present invention provides a disk apparatus that can mount media such as plural kinds of cartridges and disks having different shapes, and the device that can mount such media also can be applied to media other than DVDs and BDs.

1. A disk apparatus comprising:
a motor for rotating a disk having an information recording layer;
a head for recording information onto the information recording layer and/or reproducing the information of the information recording layer;
a tray on which a first cartridge and a second cartridge that accommodate the disk respectively and have different outside shapes can be mounted selectively;
a transferer for transferring between: a mounting position where the first cartridge or the second cartridge is mounted on the tray; and a recording/reproducing position where the head records and/or reproduces the information with respect to the information recording layer;
a detector for detecting an outside shape difference between the first cartridge and the second cartridge;
a disk cartridge guide for positioning the respective cartridges such that, when mounting the respective cartridges on the tray, centers of the respective disks accommodated in the respective cartridges do not coincide with each other; and
a transferring distance changer that can change a transferring distance of the tray of the transferer based on a result of the detector, and can transfer the tray to a position where the centers of the respective disks accommodated in the respective cartridges coincide with a substantial center of the motor.

2. The disk apparatus according to claim 1, wherein a simplex of the disk can be mounted selectively on the tray, and a center of the simplex of the disk when being mounted on the tray substantially coincides with a center of the disk accommodated in the first cartridge or the second cartridge when being mounted on the tray.

3. A disk apparatus comprising:
a motor for rotating a disk having an information recording layer;
a head for recording information onto the information recording layer and/or reproducing the information of the information recording layer;
a tray on which a simplex of the disk, a first cartridge and a second cartridge that accommodate the disk respectively and have different outside shapes can be mounted selectively;
a transferer for transferring between: a mounting position where the simplex of the disk, the first cartridge or the second cartridge is mounted on the tray; and a recording/reproducing position where the head records and/or reproduces the information with respect to the information recording layer;
a detector for detecting an outside shape difference between the simplex of the disk, the first cartridge and the second cartridge;
a disk cartridge guide for positioning the respective cartridges such that, when mounting the respective cartridges on the tray, centers of the respective disks accommodated in the respective cartridges do not coincide with each other, wherein, when mounting the simplex of the disk on the tray, the center of the simplex of the disk substantially coincides with the center of the disk accommodated in the first cartridge or the second cartridge when being mounted on the tray;
and further comprising a transferring distance changer that can change a transferring distance of the tray of the transferer based on a result of the detector, and can transfer the tray to a position where a center of the simplex of the disk and the centers of the respective disks accommodated in the respective cartridges coincide with a substantial center of the motor.

4. The disk apparatus according to claim 1, wherein
each of the first cartridge and the second cartridge is provided with one or more positioning holes, the first cartridge and the second cartridge have different distances between the positioning holes of the respective cartridges and the centers of the disks accommodated in the respective cartridges, and
the disk cartridge guide is a positioning pin that protrudes or is protrudable from the tray, and is inserted into the positioning hole.

5. The disk apparatus according to claim 4, wherein an inclined portion is formed on a tip of the positioning pin, and the inclined portion is inclined such that a side of the mounting position in a transferring direction of the tray by the transferer is close to a mounting face of the tray.

6. The disk apparatus according to claim 4, further comprising a pin cover that is disposed on a periphery of the positioning pin, and is buried under a mounting face of the tray when the respective cartridges are mounted.

7. The disk apparatus according to claim 6, wherein the pin cover is operated by being guided by the positioning pin.

8. The disk apparatus according to claim 6, wherein the simplex of the disk selectively can be mounted on the tray, and the pin cover functions also as a guide when the simplex of the disk is mounted on the tray.

9. The disk apparatus according to claim 6, wherein the simplex of the disk selectively can be mounted on the tray, and the pin cover is disposed so as to be extended in a radial manner in a substantial diameter direction of a circle whose center coincides with the center of the simplex of the disk when mounting the simplex of the disk.

10. The disk apparatus according to claim 9, wherein the pin cover is provided with an inclined face so as to be closer to the mounting face of the tray as being extended in the radial manner.

11. The disk apparatus according to claim 10, wherein an inclining direction of the inclined face of the pin cover substantially coincides with an inclining direction of an inclined portion of the positioning pin.

12. The disk apparatus according to claim 3, wherein
each of the first cartridge and the second cartridge is provided with one or more positioning holes, the first cartridge and the second cartridge have different distances between the positioning holes of the respective cartridges and the centers of the disks accommodated in the respective cartridges, and
the disk cartridge guide is a positioning pin that protrudes or is protrudable from the tray, and is inserted into the positioning hole.

13. The disk apparatus according to claim 12, wherein an inclined portion is formed on a tip of the positioning pin, and the inclined portion is inclined such that a side of the mounting position in a transferring direction of the tray by the transferer is close to a mounting face of the tray.

14. The disk apparatus according to claim 12, further comprising a pin cover that is disposed on a periphery of the positioning pin, and is buried under a mounting face of the tray when the respective cartridges are mounted.

15. The disk apparatus according to claim 14, wherein the pin cover is operated by being guided by the positioning pin.

16. The disk apparatus according to claim 14, wherein the simplex of the disk selectively can be mounted on the tray, and the pin cover functions also as a guide when the simplex of the disk is mounted on the tray.

17. The disk apparatus according to claim 14, wherein the simplex of the disk selectively can be mounted on the tray, and the pin cover is disposed so as to be extended in a radial manner in a substantial diameter direction of a circle whose center coincides with the center of the simplex of the disk when mounting the simplex of the disk.

18. The disk apparatus according to claim 17, wherein the pin cover is provided with an inclined face so as to be closer to the mounting face of the tray as being extended in the radial manner.

19. The disk apparatus according to claim 18, wherein an inclining direction of the inclined face of the pin cover substantially coincides with an inclining direction of an inclined portion of the positioning pin.
